(19) United States
(12) Patent Application Publication
(10) Pub. No.: US 2025/0314749 A1
(43) Pub. Date: Oct. 9, 2025

(54) Alternating Pulsed Lidar

(71) Applicant: The Boeing Company, Arlington, VA (US)

(72) Inventors: Nathan D. Hiller, Irvine, CA (US); Claudia E. Fritz-Thompson, Bothell, WA (US)

(21) Appl. No.: 18/630,135

(22) Filed: Apr. 9, 2024

(51) Int. Cl. G01S 7/484; G01K 11/32; G01P 5/26; G01S 17/88

(52) U.S. Cl. CPC G01S 7/484; G01S 17/88; G01K 11/32; G01P 5/26

(57) ABSTRACT

An alternating pulsed lidar system comprising a laser beam generator, a receiver, and an analyzer. The laser beam generator is configured to sequentially emit laser beam pulses from ports for an aircraft into an atmosphere on an alternating basis between the ports. The receiver is configured to receive a backscatter light generated in response to sequentially emitting the laser beam pulses and generate backscatter data from the backscatter light. The analyzer is configured to determine a set of parameters for the aircraft using the backscatter data.

### BACKGROUND INFORMATION

### 1. Field

The present disclosure relates generally to aircraft and, in particular, to laser sensor systems in aircraft.

### 2. Background

Laser-based sensor systems can replace many vital aircraft instruments and add new capabilities for aircraft. For example, a light detection and ranging (LIDAR) sensor can be used to measure the speed of an aircraft. With a lidar sensor, a laser beam is emitted into the air. The laser beam encounters aerosols in the air that reflect or “backscatter” light toward the aircraft. Aerosols are fine solid particles, liquid particles, or both, suspended in air or other gases. The backscatter of the laser beam can also be caused by the molecules of air.

The backscatter light generated in response to emitting the laser beam is detected. The speed of the aircraft can be determined by comparing the frequency of the laser beam to the frequency in the backscatter. This shift in frequency is a Doppler effect that can be used to calculate the speed of the aircraft. These types of laser-based sensor systems can also be used to measure other parameters such as temperature and air density.

With aircraft, multiple laser beams are pulses of laser beams transmitted from three or more ports in aircraft. Backscatter light is generated in response to these laser beam pulses being scattered by aerosols in the atmosphere. The backscatter light detected is used to determine parameters such as airspeed and temperature.

### SUMMARY

An embodiment of the present disclosure provides an alternating pulsed lidar system comprising a laser beam generator, a receiver, and an analyzer. The laser beam generator is configured to sequentially emit laser beam pulses from ports for an aircraft into an atmosphere on an alternating basis between the ports. The receiver is configured to receive a backscatter light generated in response to sequentially emitting the laser beam pulses and generate backscatter data from the backscatter light. The analyzer is configured to determine a set of parameters for the aircraft using the backscatter data.

Another embodiment of the present disclosure provides an alternating pulsed lidar system comprising a laser beam generator, a receiver, and an analyzer. The laser beam generator comprises a laser source configured to generate a laser beam and a switch configured to receive the laser beam from the laser source; split the laser beam into multiple laser beams; and switch the multiple laser beams to different subsets of ports for an aircraft on an alternating basis to sequentially emit the multiple laser beam pulses from the different subsets of ports into the atmosphere on the alternating basis between different subsets of ports. The receiver is configured to receive backscatter light generated in response to sequentially emitting the laser beam pulses from the different subsets of ports and generate backscatter data from the backscatter light. The analyzer is configured to determine a set of parameters for the aircraft using the backscatter data.

Yet another embodiment of the present disclosure provides a method for backscatter light detection. Laser beam pulses are sequentially emitted from ports for an aircraft into an atmosphere on an alternating basis between the ports. A backscatter light generated in response to sequentially emitting the laser beam pulses is received. Backscatter data is generated from the backscatter light. A set of parameters for the aircraft is determined using the backscatter data.

Still another embodiment of the present disclosure provides a synchronized alternating pulsed lidar system comprising a laser source, a switch, a receiver, and a controller. The laser source is configured to a laser beam. The switch is configured to receive the laser beam from the laser source and switch the laser beam received from the laser source to ports for a rotorcraft on an alternating basis to sequentially emit laser beam pulses from the ports for the rotorcraft into an atmosphere on the alternating basis between the ports. The receiver is configured to receive a backscatter light generated in response to sequentially emitting the laser beam pulses and generate backscatter data from the backscatter light. The controller is configured to control the switch to sequentially emit the laser beam pulses from the ports on the alternating basis such that the laser beam pulses from the ports avoid hitting blades on the rotorcraft.

Another embodiment of the present disclosure provides a synchronized alternating pulsed lidar system comprising a laser beam generator, a receiver, and an analyzer. The laser beam generator is configured to sequentially emit laser beam pulses from ports for an aircraft into an atmosphere on an alternating basis between the ports. The receiver is configured to receive a backscatter light generated in response to sequentially emitting the laser beam pulses and generate backscatter data from the backscatter light. The analyzer is configured to control the laser beam generator to sequentially emit the laser beam pulses from the ports on the alternating basis with an emission rate that sweeps from a first rate to a second rate and determine a rotor rotation rate using the backscatter data.

Yet another embodiment of the present disclosure provides an alternating pulsed lidar system comprising a laser beam generator, a receiver, and an analyzer. The laser beam generator comprises a laser source configured to generate a pulsed laser beam with a pulse rate and a switch configured to receive the pulsed laser beam from the laser source and switch the pulsed laser beam received from the laser source to ports for a rotorcraft on an alternating basis to sequentially emit laser beam pulses from the ports into the atmosphere on the alternating basis between the ports. The receiver is configured to receive backscatter light generated in response to sequentially emitting the laser beam pulses from the ports and generate backscatter data from the backscatter light. The analyzer is configured to change a switch rate at which the switch switches a pulsed laser beam to emit the laser beam pulses from the ports and determine the pulse rate for the pulsed laser beam using the backscatter data.

Still another embodiment of the present disclosure provides an alternating pulsed lidar system comprising a laser beam generator, a receiver, and an analyzer. The laser beam generator comprises a laser source configured to generate a pulsed laser beam with a pulse rate and a switch configured to receive the pulsed laser beam from the laser source and switch the pulsed laser beam received from the laser source to ports for a rotorcraft on an alternating basis with a switch rate to sequentially emit laser beam pulses from the ports into the atmosphere on the alternating basis between the ports. The receiver is configured to receive backscatter light generated in response to sequentially emitting the laser beam pulses from the ports and generate backscatter data from the backscatter light. The analyzer is configured to change the pulse rate for the pulsed laser beam and determine the switch rate for the switch using the backscatter data.

Another embodiment of the present disclosure provides a temporally filtered lidar system comprising a laser beam generator, a receiver, and an analyzer. The laser beam generator is configured to sequentially emit laser beam pulses from ports for an aircraft into an atmosphere on an alternating basis between the ports. The receiver is configured to receive a backscatter light generated in response to sequentially emitting the laser beams pulses and generate backscatter data from the backscatter light having a power level being less than a threshold for the backscatter light being generated in response to the laser beam pulses scattering from aerosols in the atmosphere. The analyzer is configured to determine a set of parameters for the aircraft using the backscatter data.

Another embodiment of the present disclosure provides a temporally filtered lidar system comprising a laser beam generator, a receiver, and an analyzer. The laser beam generator is configured to sequentially emit laser beam pulses from ports for an aircraft into an atmosphere on an alternating basis between the ports and emit a continuous wave laser beam into the atmosphere. The receiver is configured to receive a backscatter light generated in response to the laser beam pulses and the continuous wave laser beam; separate a portion of the backscatter light having a power level greater than a threshold for the backscatter light generated in response to the laser beam pulses being scattered by an aerosol in the atmosphere; and generate backscatter data from unseparated backscatter light. The analyzer is configured to determine a set of parameters for the aircraft using the backscatter data.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is a block diagram of a sensor environment in accordance with an illustrative embodiment;

FIG. 3 is an illustration of a graph of standard deviation accuracy in accordance with an illustrative embodiment;

FIG. 4 is an illustration of a switching system in accordance with an illustrative embodiment;

FIG. 5 is an illustration of laser beam pulse synchronization using sequentially switched laser beam pulses in accordance with an illustrative embodiment;

FIG. 6 is an illustration of relative intensity of backscatter light and a laser beam from a laser in accordance with an illustrative embodiment;

FIG. 7 is an illustration of relative intensity of backscatter light and a laser beam from a laser in accordance with an illustrative embodiment;

FIG. 8 is an illustration of relative intensity of backscatter light and a laser beam from a laser in accordance with an illustrative embodiment;

FIG. 9 is an illustration of a filter system for temporally filtering backscatter light in accordance with an illustrative embodiment;

FIG. 10 is an illustration of a lidar pulse trigger in accordance with an illustrative embodiment;

FIG. 11 is an illustration of a flowchart of a process for backscatter light detection in accordance with an illustrative embodiment;

FIG. 12 is an illustration of a flowchart of a process for sequentially emitting laser beam pulses in accordance with an illustrative embodiment;

FIG. 13 is an illustration of a flowchart of a process for synchronizing emission of laser beam pulses in accordance with an illustrative embodiment;

FIG. 14 is an illustration of a flowchart of a process for synchronizing emission of laser beam pulses in accordance with an illustrative embodiment;

FIG. 15 is an illustration of an aircraft manufacturing and service method in accordance with an illustrative embodiment; and

FIG. 16 is an illustration of a block diagram of an aircraft in which an illustrative embodiment may be implemented.

### DETAILED DESCRIPTION

The illustrative embodiments recognize and take into account one or more different considerations as described herein. With laser sensor systems, such as lidar systems, the amount of backscatter light generated depends on the atmospheric conditions. As the density of the aerosol increases, the backscatter coefficient for the amount of backscatter light generated increases, resulting in increased backscatter light from laser beams emitted into the atmosphere. Typically, the backscatter coefficient for density of aerosols decreases as the altitude increases.

As a result, higher altitudes can result in unfavorable atmospheric conditions for using lidar systems. For example, atmospheric conditions at 2 kilometers are much better for lidar systems as compared to 12 kilometers. Scattering levels can easily vary by 1000 times between different altitudes. However, it is desirable for lidar systems to be able to actively operate with low backscatter light levels at higher altitudes.

Currently used lidar systems split the laser beam into three or more pulses that are emitted for use in determining parameters such as airspeed. Splitting of the laser beam reduces the energy in each laser beam. As a result, in lower aerosol density conditions, the ability of this type of lidar system to provide a desired level of backscatter detection is reduced.

Further, for direct detection lidar, the standard deviation accuracy of a lidar system depends only on backscatter energy. With coherent lidar systems, the standard deviation accuracy depends on backscatter energy and pulse rate. For high backscatter energy, increased accuracy occurs with a higher pulse rate. For lower backscatter energy, accuracy increases with a lower pulse rate.

Tuning of laser beam pulse rates for many currently available laser sources is limited. Typically, the laser beam pulse rate is much higher than the sampling rate for the backscatter light. As a result, splitting laser beams for transmission from ports in the aircraft is not necessary for obtaining the desired sampling rate.

Instead, the laser beam emitted from the source can be switched between the ports in the aircraft. The switching can result in a lower pulse rate that is still greater than the sampling rate needed. As a result, the energy in each pulse can be higher through the switching as compared to splitting a laser beam into multiple pulses.

Thus, the accuracy in detection can be increased. This accuracy can be standard deviation accuracy. The standard deviation accuracy for a lidar system is the expected range of variation between measured data points and their true positions. The standard deviation accuracy represents the level of uncertainty in the accuracy of the measurements by the lidar system that is expressed as a statistical measure such as standard deviation.

The illustrative embodiments provide a method, apparatus, and system for improving the generation of backscatter light for lidar systems. This type of improvement is especially useful for coherent lidar systems.

In one illustrative example, an alternating pulsed lidar system is comprised of a laser beam generator, a receiver, and an analyzer. The laser beam generator is configured to sequentially emit laser beam pulses from ports for an aircraft into an atmosphere on an alternating basis between the ports. The receiver is configured to receive a backscatter light generated in response to sequentially emitting the laser beam pulses and generate backscatter data from the backscatter light. The analyzer is configured to determine a set of parameters for the aircraft using the backscatter data.

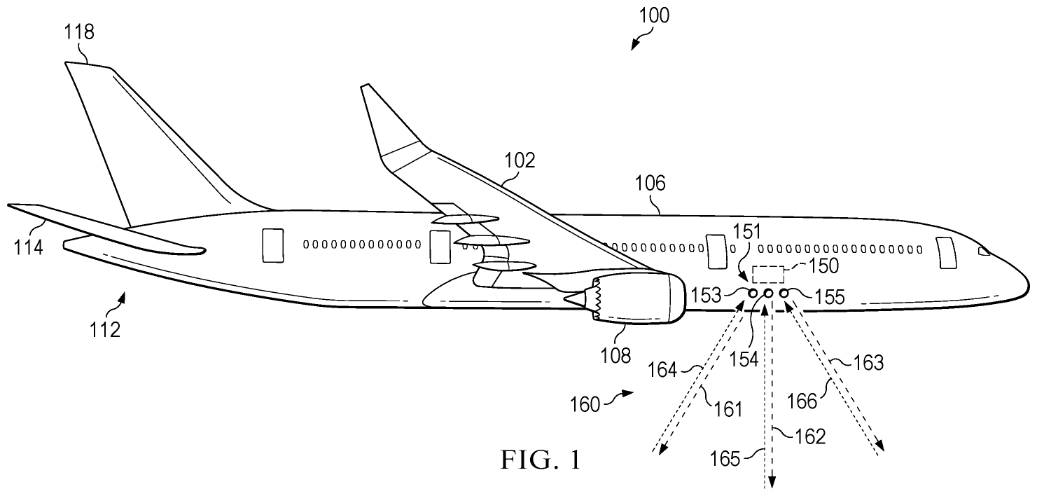

With reference now to the figures, and in particular, with reference to FIG. 1, an illustration of an aircraft is depicted in accordance with an illustrative embodiment. In this depicted example, airplane 100 has wing 102 attached to body 106. Airplane 100 includes engine 108 attached to wing 102. Another wing and engine are present but not shown in this view.

Body 106 has tail section 112. Horizontal stabilizer 114 and vertical stabilizer 118 are attached to tail section 112 of body 106. Another horizontal stabilizer is also present but not seen in this view.

Airplane 100 is an example of an aircraft in which alternating pulsed lidar system 150 can be implemented in accordance with an illustrative embodiment. In this example, alternating pulsed lidar system 150 emits laser beam pulses 160 from ports 151. As depicted, laser beam pulses 160 includes laser beam pulse 161, laser beam pulse 162, and laser beam pulse 163. In this example, ports 151 include port 153 from which laser beam pulse 161 is emitted; port 154 from which laser beam pulse 162 is emitted; and port 155 from which laser beam pulse 163 is emitted.

In response to the emission of these laser beam pulses, backscatter light is generated. For example, laser beam pulse 161 results in backscatter light 164 and laser beam pulse 162 results in backscatter light 165. The emission of laser beam pulse 163 results in the generation of backscatter light 166.

In this illustrative example, a pulsed laser beam is sequentially switched between ports 151. This switching of the pulsed laser beam to emit laser beam pulse 161, laser beam pulse 162, and laser beam pulse 163 is such that the rate of emission is within the sampling rate desired for the backscatter light.

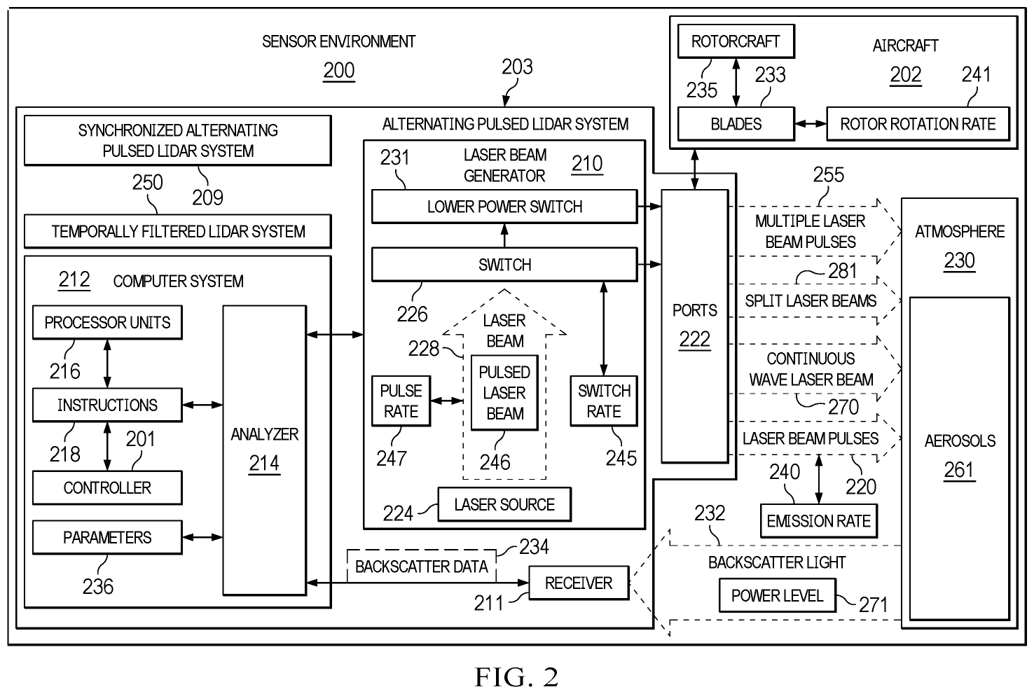

With reference now to FIG. 2, a block diagram of a sensor environment is depicted in accordance with an illustrative embodiment. In this illustrative example, aircraft 202 in sensor environment 200 has alternating pulsed lidar system 203 for aircraft 202. Alternating pulsed lidar system 150 is an example of an implementation for alternating pulsed lidar system 203, and airplane 100 is an example of an implementation for aircraft 202.

Alternating pulsed lidar system 203 can be implemented in aircraft 202. In other examples, alternating pulsed lidar system 203 can be located in the payload connected to aircraft 202.

In this illustrative example, aircraft 202 can take a number of different forms. For example, aircraft 202 can be an airplane, a commercial aircraft, a rotorcraft, a helicopter, a tilt-rotor aircraft, a tilt wing aircraft, a vertical takeoff and landing aircraft, an electrical vertical takeoff and landing vehicle, a personal air vehicle, an unmanned aerial vehicle, a drone, and other suitable types of aircraft.

Alternating pulsed lidar system 203 is comprised of a number of different components. As depicted, alternating pulsed lidar system 203 comprises laser beam generator 210, receiver 211, computer system 212, and analyzer 214.

Laser beam generator 210 can sequentially emit laser beam pulses 220 from ports 222 for aircraft 202 into an atmosphere on an alternating basis between ports 222. In this example, laser beam 228 can be switched by laser beam generator 210 using different ports in ports 222 to emit laser beam pulses 220 from ports 222. In this example, laser beam pulses 220 are emitted sequentially from ports 222 on an alternating basis between ports 222. Ports 222 can be in aircraft 202 or a payload connected to aircraft 202.

In this illustrative example, three or more ports are used to determine parameters 236 for aircraft 202 such as airspeed and direction. In another example, two ports can be used to determine atmospheric parameters such as temperature or humidity.

With this type of switching, laser beam 228 is not split. As a result, reduction of power that normally occurs from splitting a laser beam does not occur with laser beam generator 210 emitting laser beam pulses 220. In this example, each laser beam pulse has the same energy as laser beam 228. Thus, sequentially emitting laser beam pulses 220 on an alternating basis between ports 222 causes at least one of avoiding reducing the power of laser beam pulses 220 or reducing the drop in the power of the laser beam pulses 220 with respect to laser beam 228.

In this illustrative example, laser beam generator 210 comprises laser source 224 and switch 226. Laser source 224 generates laser beam 228. In this example, laser source 224 generates laser beam 228 that is at least one of a continuous wave laser beam or a pulsed laser beam that is sent to switch 226.

Switch 226 receives laser beam 228 from laser source 224. Switch 226 switches laser beam 228 received from laser source 224 to ports 222. Switch 226 can be selected from a group comprising an optical switch and an optical fiber switch, a micro-electro-mechanical system switch, and other switches suitable for switching light.

The switching of laser beam 228 is performed on an alternating basis to sequentially emit laser beam pulses 220 from ports 222 for aircraft 202 into atmosphere 230 on an alternating basis between ports 222. In this example, switch 226 is optically connected to laser source 224 and to ports 222. The connection can be made using optical fibers or other media that can transmit light.

In one example, if two ports are present, laser beam 228 is switched such that laser beam pulses 220 are emitted alternating between the first port and the second port. In another example, if four ports are present, laser beam 228 is switched such that laser beam pulses 220 are sequentially emitted through the first port, second port, third port, and fourth port.

In this illustrative example, backscatter light 232 is generated in response to laser beam pulses 220 being emitted into atmosphere 230. Receiver 211 can receive backscatter light 232 generated in response to sequentially emitting laser beam pulses 220. In this example, receiver 211 generates backscatter data 234 from backscatter light 232 detected by receiver 211. This backscatter data is sent to analyzer 214.

In this illustrative example, analyzer 214 determines a set of parameters 236 for aircraft 202 using backscatter data 234. For example, the set of parameters 236 can be selected from at least one of an airspeed, a temperature, an air density, an angle of sideslip, an angle of attack, wind speed, ice, aerosol properties, a presence of insects, turbulence, open air turbulence, or other suitable parameters.

As used herein, “a set of” when used with reference to items, means one or more items. For example, “a set of parameters 236” is one or more of parameters 236.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this depicted example, analyzer 214 is located in computer system 212 and can be implemented in software, hardware, firmware, or a combination thereof. When software is used, the operations performed by analyzer 214 can be implemented in program instructions configured to run on hardware, such as a processor unit. When firmware is used, the operations performed by analyzer 214 can be implemented in program instructions and data stored in persistent memory to run on a processor unit. When hardware is employed, the hardware can include circuits that operate to perform the operations in analyzer 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices.

As used herein, “a number of” when used with reference to items, means one or more items. For example, “a number of operations” is one or more operations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes for analyzer 214 in the illustrative examples. In other words, program instructions 218 are computer-readable program instructions.

Thus, alternating pulsed lidar system 203 can operate to provide a higher level of power for generating backscatter light 232 as compared to current systems that split a laser beam for emission. By switching laser beam 228 to different ports to emit laser beam pulses in a sequential basis, the issue with a reduction in power from splitting a laser beam in multiple pulses is reduced. This type of switching in alternating pulsed lidar system 203 increases the performance in generating backscatter light 232 at lower scattering levels that occur from lower concentrations of aerosols 261 in atmosphere 230.

In these examples, laser beam pulses 220 can have a greater rate or the same rate as the sampling rate that is desired. Further with this example, laser beam pulses 220 can be N laser beam pulses that are sequentially emitted at a rate that is N times a sampling rate for backscatter light 232.

In one example, the rate of laser beam pulses 220 generated by laser beam generator 210 can, to a certain extent, be set by frequency of laser beam 228. The frequency can be further lowered by switch 226. Thus, laser beam pulses 220 can still have a greater rate than the sampling rate.

In another illustrative example, laser beam generator 210 can include another switch such as low power switch 231. With this example, low power switch 231 can receive laser beam 228. Laser beam 228 received by switch 226 can be sent to low power switch 231 when switch 226 is positioned to send laser beam 228 to low power switch 231 instead of to ports 222. In this case, low power switch 231 splits laser beam 228 to form split laser beams 281 and sends split laser beams 281 to ports 222 for emission into atmosphere 230.

With this illustrative example, switch 226 is configured to send laser beam 228 to low power switch 231 in response to a determination that the set of parameters 236 has a deviation greater than the threshold. The threshold can be when the airspeed determined from backscatter data 234 fluctuates by more than 5 knots per second and that fluctuations occur 10 or more times in a 30 second period of time. Splitting the laser beam can reduce errors in analyzing backscatter light 232.

In another illustrative example, switch 226 can receive laser beam 228 from laser source 224 and split laser beam 228 into multiple laser beams. Switch 226 can send the multiple laser beams to different subsets of ports 222 for aircraft 202 on an alternating basis to sequentially emit multiple laser beam pulses 255 from the different subsets of ports into atmosphere 230 on the alternating basis between different subsets of ports 222.

For example, the multiple laser beams can be two laser beams and ports 222 can comprise three ports-a first port, a second port, and a third port. The two laser beams can be emitted from ports 222 from different subsets of these ports. For example, the two laser beams can be emitted from the first port and the second port by switch 226. Switch 226 can then send the multiple laser beams to emit multiple laser beam pulses 255 from the second port and the third port. Next, switch 226 can emit multiple laser beam pulses 255 from the third port and the first port. In these examples, the emission of multiple laser beam pulses 255 are simultaneous emissions from a subset of ports 222.

This type of emission of laser beams can be performed to reduce errors in measurements. With this type of emission, backscatter light 232 can be received from multiple laser beam emissions instead of from a single emission for a particular period of time.

Further, in another illustrative example, aircraft 202 can be rotorcraft 235 with blades 233. Rotorcraft 235 can be, for example, a helicopter, a propeller aircraft, a tiltrotor aircraft, or some other type of rotorcraft. In this example, alternating pulsed lidar system 203 is a coherent lidar system in which the timing of laser beam pulses 220 can be selected to reduce issues with laser beam pulses 220 hitting blades 233.

With this example, receiver 211 can identify backscatter light 232 occurring from laser beam pulses 220 hitting a blade on rotorcraft 235. Analyzer 214 can filter out backscatter light 232 occurring from laser beam pulses 220 hitting the blade. Backscatter light 232 occurring from hitting a blade can have a higher power level as compared to backscatter occurring from laser beam pulses 220 encountering aerosols 261 in atmosphere 230. Measurements can be made from backscatter light 232 hitting blades 233 on rotorcraft 235. With these measurements, the threshold for backscatter light 232 can be used to determine when to filter out backscatter light 232.

In another illustrative example, alternating pulsed lidar system 203 can be synchronized alternating pulsed lidar system 209 used with rotorcraft 235. The emission of laser beam pulses 220 thereby avoids hitting blades 233. Synchronized alternating pulsed lidar system 209 can be one of a coherent lidar system and a direct detection lidar system.

In this illustrative example, synchronized alternating pulsed lidar system 209 can also include controller 201. Controller 201 can also be implemented in at least one of software, firmware, or hardware. In similar fashion, the number of processor units 216 are capable of executing program instructions 218 implementing processes for controller 201.

In this illustrative example, controller 201 can control switch 226 to sequentially emit laser beam pulses 220 from ports 222 on an alternating basis such that laser beam pulses 220 from ports 222 avoid hitting blades 233 on rotorcraft 235. Further in this example, backscatter light 232 can be analyzed by analyzer 214 to identify a time for controller 201 to use in controlling switch 226 such that laser beam pulses 220 avoid hitting blades 233. As a result, controller 201 can control a timing of sequentially emitting laser beam pulses 220 from ports 222 for rotorcraft 235 into atmosphere 230 on an alternating basis such that laser beam pulses 220 from ports 222 avoid hitting blades 233 on rotorcraft 235.

In controlling the timing, controller 201 can control switch 226 to sequentially emit laser beam pulses 220 from ports 222 on the alternating basis such that laser beam pulses 220 from ports 222 avoid hitting blades 233 on rotorcraft 235. In this example, the timing can be controlled using a time delay that causes laser beam pulses 220 from ports 222 to avoid hitting blades 233 on rotorcraft 235.

The time delay can be determined by matching the rotor rotation rate 241 of blades 233 to the pulse rate or any integer of the pulse rate for laser beam pulses 220. In selecting the time dela for avoiding blades 233, the time delay can be swept until the backscatter is minimized, indicating that the laser beam pulses 220 are not hitting blades 233.

In this example, alternating pulsed lidar system 203 can also operate to determine rotor rotation rate 241 of blades 233. For example, analyzer 214 can control laser beam generator 210 to sequentially emit laser beam pulses 220 from ports 222 on an alternating basis with emission rate 240 for laser beam pulses 220 that sweeps from a first rate to a second rate. Further, analyzer 214 can determine rotor rotation rate 241 using backscatter data 234 received from receiver 211.

Rotor rotation rate 241 for blades 233 on rotorcraft 235 can be determined in a number of different ways. In one example, the rotation rate can be determined from knowing the location of the laser beam spot on the rotor blade, the angle at which the beam strikes the rotor blade, and the frequency shift of the light backscattered from the blade.

In another example, rotor rotation rate 241 can be measured from the frequency response of the backscatter light 232. If the average backscatter power in backscatter data 234 for backscatter light 232 appears to be random over time, the pulse rate does not match the rotation rate. If the average backscatter power is fixed over time, then the frequencies are matched. In this example, the time can be the time for one complete rotation of blades 233. In yet another example, rotor rotation rate 241 can also be determined by taking the Fast Fourier Transform of the backscatter power.

In yet another illustrative example, alternating pulsed lidar system 203 can operate to determine switch rate 245 for switch 226. In this example, laser beam 228 is pulsed laser beam 246 and switch rate 245 for switch 226 is known.

In this example, analyzer 214 can change switch rate 245 at which switch 226 operates in emitting laser beam pulses 220 from ports 222. For example, analyzer 214 can control switch rate 245 at which switch 226 switches pulsed laser beam 228 to ports 222 in emitting laser beam pulses 220 from ports 222. Analyzer 214 determines pulse rate 247 for the pulsed laser beam 246 using backscatter data 234. This determination can be made knowing switch rate 245.

As another illustrative example, alternating pulsed lidar system 203 can operate to determine pulse rate 247. Analyzer 214 can change pulse rate 247 for pulsed laser beam 246. Further, analyzer 214 can determine switch rate 245 for switch 226 using backscatter data 234. In this case, pulse rate 247 for pulsed laser beam 246 is known and is used in determining switch rate 245.

For example, if switch rate 245 is not equal to pulse rate 247, laser beam pulses 220 are blocked by blades 233 at some times and pass through blades 233 at other times. Whether laser beam pulses 220 are blocked or passed through blades 233 can be determined by monitoring the power output of all laser beam pulses 220 from different ports in ports 222. In this case, the power will appear to be random, and the total power for all the laser beams fluctuates randomly.

In another example, if switch rate 245 is equal to pulse rate 247, laser beam pulses 220 are never blocked by blades 233 or are always blocked by blades 233. Further if laser beam pulses 220 are partially blocked by blades 233, laser beam pulses 220 are always partially blocked in this example. In either of these situations, the sum total power output from all the beams is fixed without any randomness.

Switch rate 245 can be changed over a range of expected switching frequencies and the power output of all laser beam pulses 220 can be measured. When the measurements indicate that fixed powers are present when summing the total power of laser beam pulses 220, the measured power is considered fixed and switch rate 245 is known.

In yet another illustrative example, alternating pulsed lidar system 203 can operate as temporally filtered lidar system 250. This filtering can be performed for temporally filtered lidar system 250 as a coherent lidar system or direct lidar system. For example, temporally filtered lidar system 250 can filter out backscatter light 232 resulting from laser beam pulses 220 hitting blades 233.

With this example, receiver 211 can include components that are configured or designed to filter out undesired backscatter light 232. For example, receiver 211 can receive backscatter light 232 generated in response to sequentially emitting laser beam pulses 220. Receiver 211 can generate backscatter data 234 from backscatter light 232 having a power level 271 being less than a threshold for backscatter light 232 being generated in response to laser beam pulses 220 scattering from aerosols 261 in the atmosphere 230. Backscatter data can be processed by analyzer 214 to generate a set of parameters 236 for rotorcraft 235.

In this illustrative example, the threshold can be selected based on power level 271. For example, the threshold can be a value for the power level 271 of backscatter light 232 that is an order of 2 to 3 times the magnitude for backscatter light 232 expected for backscatter light 232 generated by aerosols 261.

In this example, a portion of backscatter light 232 is not used to generate backscatter data 234 as power level 271 of backscatter light 232 is greater than the threshold for laser beam pulses 220 being scattered by aerosols 261. This portion of backscatter light 232 is backscatter light 232 generated by laser beam pulses 220 hitting blades 233 and can be used to determine at least one of a rotor rotation rate 241, a contaminant accumulation is present on blades 233, a temperature of blades 233, or other parameters with respect to blades 233.

The determination of these and other parameters for blades 233 using backscatter light 232 can be used for various actions. For example, contaminant accumulation can be used to determine when cleaning is needed for blades 233. As another example, the determination of rotor rotation rate 241 can be used to calibrate the emission of laser beam pulses 220. Also, the temperature can be used to determine wear and tear for blades 233 and make longevity assessments for blades 233.

Further, blades 233 can have a reflective coating on an underside of blades 233. The reflective coating can be selected to increase backscatter light 232 generated by laser beam pulses 220 hitting the underside of blades 233. Reflectivity can make it easier to distinguish when backscatter light 232 is generated by blades 233 rather than aerosols 261.

For example, wherein the reflective coating can be temperature dependent for temperature measurements, this coating can improve temperature measurements of blades 233. The coating can have changes in reflectivity, absorption, or fluorescence properties in response to temperature fluctuations. These changes can then be correlated with known characteristics of the coating to determine the temperature of the surface of blades 233 when a laser beam pulse hits the surface of blades 233 generating backscatter light 232.

In another illustrative example, temporally filtered lidar system 250 can also emit continuous wave laser beam 270 into atmosphere 230 in addition to laser beam pulses 220. In this example, continuous wave laser beam 270 can be optimized to generate backscatter light 232 in response to hitting blades 233. Further, continuous wave laser beam 270 can be selected to have eye-safe characteristics.

With this example, receiver 211 can receive backscatter light 232 generated in response to laser beam pulses 220 and continuous wave laser beam 270. Receiver 211 can separate a portion of backscatter light 232 having power level 271 greater than a threshold for backscatter light 232 generated in response to laser beam pulses 220 being scattered by aerosols 261 in atmosphere 230. In other words, backscatter light 232 generated by continuous wave laser beam 270 hitting blades 233 can have power level 271 that is greater than backscatter light 232 generated by laser beam pulses 220 in encountering aerosols 261. Receiver 211 can generate backscatter data 234 from unseparated backscatter light. Analyzer 214 can determine a set of parameters 236 for aircraft 202 using backscatter data 234.

The illustration of sensor environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, alternating pulsed lidar system 203 can include one or more laser beam generators in addition to laser beam generator 210 that also emits laser beam pulses for use in determining parameters 236. Laser source 224 is shown as a single block and can include one or more lasers. For example, laser source 224 can include a continuous wave laser and a pulsed laser. In yet another illustrative example, a telescope can be present that collects backscatter light 232 and sends that collected backscatter light to receiver 211.

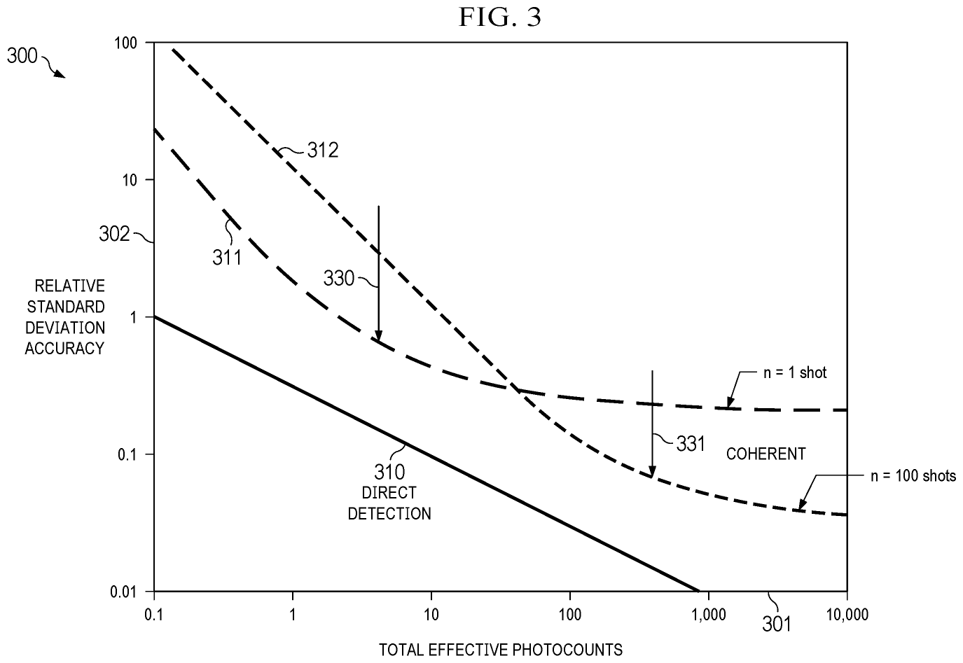

Turning next to FIG. 3, an illustration of a graph of standard deviation accuracy is depicted in accordance with an illustrative embodiment. In this illustrative example, graph 300 depicts relative standard deviation accuracy in determining parameters from backscatter light.

In graph 300, x-axis 301 is total effective photo accounts and y-axis 302 is relative standard deviation accuracy. The total effective photo counts is the total energy in the laser beam pulses. Relative standard deviation accuracy is the consistency of measurements relative to the magnitude of the backscatter light detected. A lower value indicates a higher precision level.

As depicted, line 310 is for direct detection. This line indicates that the standard deviation depends only on backscatter energy. Line 311 and line 312 show the standard deviation for a coherent lidar system. Line 311 indicates the standard deviation for a single shot. In other words, this line identifies the standard deviation for different total effective counts using a single laser beam pulse. Line 312 indicates the standard deviation for 100 shots at different total effective photo counts.

Backscatter energy increases as the densities of aerosols increase. In this illustrative example, when a high level of backscatter energy is present, a higher pulse rate for the laser beam pulses results in increased accuracy as indicated by arrow 331 through line 311 and line 312. As depicted, the relative standard deviation accuracy is lower with 100 shots as compared to one shot. Thus, the accuracy in determining parameters increases with a lower standard deviation.

In this example, with low backscatter, accuracy is best with a low pulse rate as indicated by arrow 330 through line 312 and line 311. As shown, a lower standard deviation for increase actually occurs using a single shot in line 311 as compared to 100 shots in line 312 at arrow 330.

In the illustrative example, alternating pulsed lidar system 203 in FIG. 2 can improve standard deviation accuracy by switching laser beam 228 to different ports in ports 222. Switching does not reduce the energy in generating laser beam pulses 220. This is in contrast to splitting the laser beam 228, which results in a lower energy and laser beam pulses 220. For example, splitting laser beam 228 can reduce energy and laser beam pulses 220 by 6 dB as compared to switching laser beam 228 to different ports in ports 222 to emit laser beam pulses 220. Thus, for coherent detection by alternating pulsed lidar system, standard deviation accuracy can be maintained when scattering levels decrease by using as high of an energy level as possible per laser beam pulse.

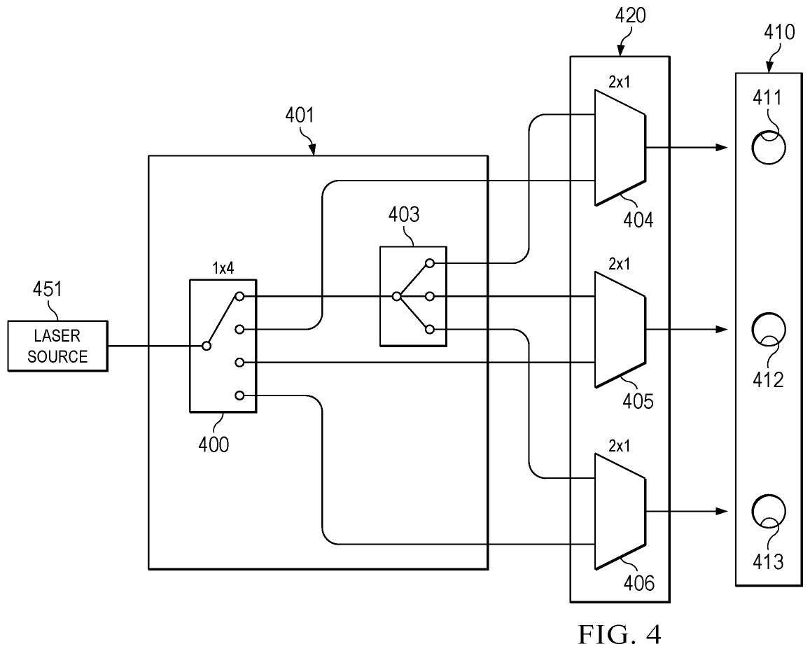

With reference now to FIG. 4, an illustration of a switching system is depicted in accordance with an illustrative embodiment. In this illustrative example, switching system 401 can be implemented in alternating pulsed lidar system 203 in FIG. 2. As depicted, switching system 401 comprises switch 400 and low power switch 403. Switch 400 is an example of switch 226 in FIG. 2 and low power switch 403 is an example of low power switch 231 in FIG. 2.

As depicted, switch 400 and low power switch 403 are connected to multiplexers 420 that comprise multiplexer 404, multiplexer 405, and multiplexer 406. These multiplexers are connected to ports 410. In this example, ports 410 include port 411, port 412, and port 413.

In this illustrative example, switch 400 can sequentially send a laser beam from laser source 451 through multiplexers 420 for emission from ports 410 as the laser beam pulses on an alternating basis and can also direct the laser beam from laser source 451 to low power switch 403. In this example, low power switch 403 includes a splitter that splits the laser beam to form split laser beams. The split laser beams are sent through multiplexers 420 from ports 410 on a simultaneous basis.

In this example, alternating pulsed lidar system 203 with switching system 401 can improve safety and reliability. With respect to safety, the aircraft can operate at a lower power mode by emitting split laser beams during times of high aerosol density. These high aerosol density situations can occur near the ground where high power pulses can be an eye hazard. During operation of the aircraft in low aerosol density situations such as at cruising altitude, alternating pulsed lidar system 203 with switching system 401 can operate in high power mode by sequentially emitting laser beam pulses. For reliability, switch 400 will last longer if it is only used when needed such as at times of low aerosol density.

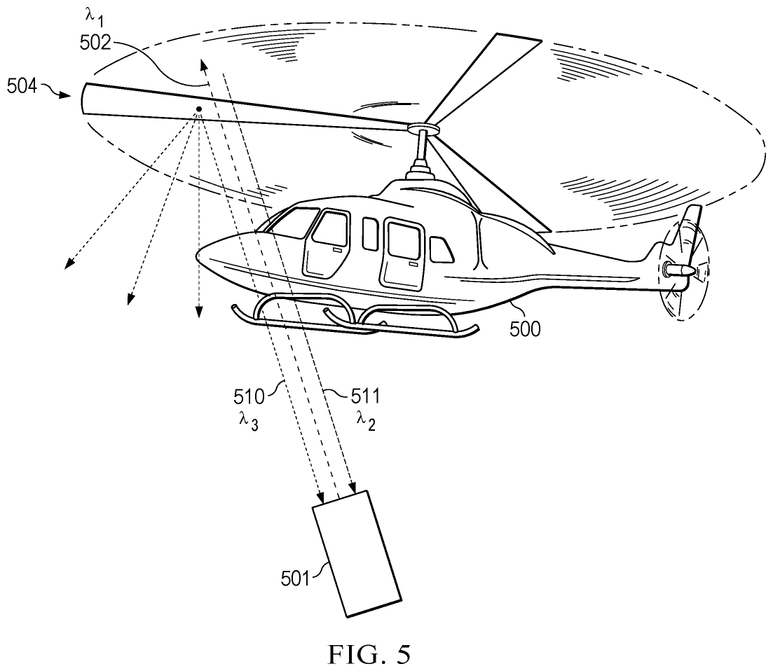

Turning next to FIG. 5, an illustration of laser beam pulse synchronization using sequentially switched laser beam pulses is depicted in accordance with an illustrative embodiment. In this illustrative example, helicopter 500 is an example of rotorcraft 235 in FIG. 2.

As depicted, laser 501 is an example of laser source 224 in FIG. 2 that emits laser beam pulses. Although laser 501 is shown as a separate component from helicopter 500, laser 501 is integrated as part of helicopter 500 for purposes of depicting synchronization of laser beam pulses.

In this example, laser 501 emits laser beam pulses 502 having a wavelength λ1. In this example, laser beam pulses 502 are emitted in the direction of blades 504 of helicopter 500. Depending on the timing of laser beam pulses 502, laser beam pulses 502 can hit blades 504. Hitting blades 504 can cause a frequency shift in the backscatter light 510 that is different from backscatter light 511 caused by laser beam pulses 502 being scattered by aerosols in the atmosphere. In this example, backscatter light 510 has wavelength λ3 as compared to backscatter light 511 which has a wavelength λ2.

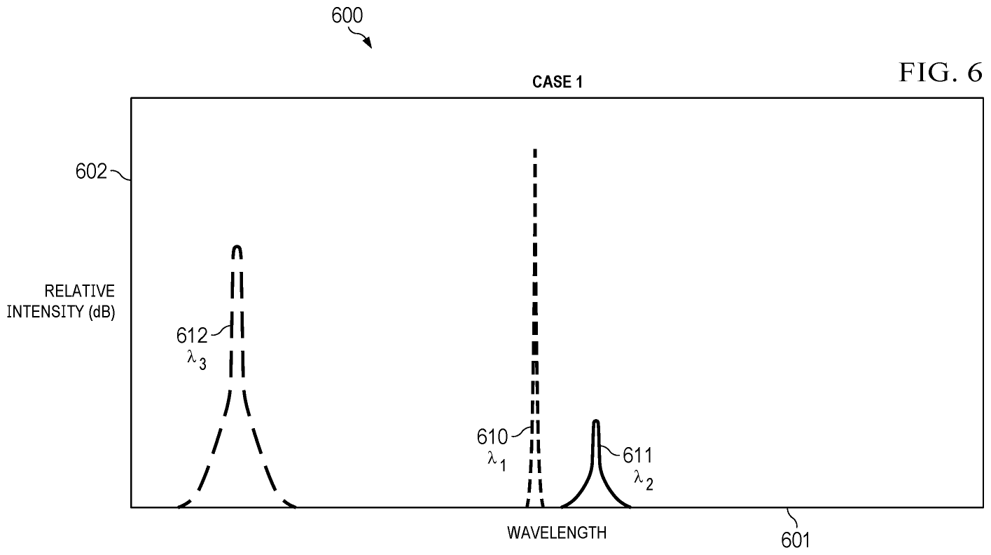

Next in FIGS. 6-8, an illustration of three cases that can occur from the emission of laser beam pulses from laser 501 in FIG. 5. The wavelengths of backscatter light detected from emitting laser beam pulses 502 can change or vary based on the angle at which laser beam pulses 502 hit blades 504 on helicopter 500.

Turning next to FIG. 6, an illustration of relative intensity of backscatter light and a laser beam from a laser is depicted in accordance with an illustrative embodiment. Graph 600 is a graph of relative intensity of light or different wavelengths. As depicted, x-axis 601 is wavelength and y-axis 602 is relative intensity.

In this example, case 1 is shown in which line 610 is intensity for laser beam pulses 502 having wavelength λ1; line 611 is intensity for backscatter light 511 having wavelength λ2; and line 612 is intensity for backscatter light 510 having wavelength λ3. In this case, backscatter light 510 from blades 504 and backscatter light 511 from aerosols in the atmosphere have wavelengths that enable filtering. In detecting backscatter light, backscatter light 510 having wavelength λ3 can be filtered using optical filters such that only backscatter light 511 with wavelength λ2 is used to generate backscatter data.

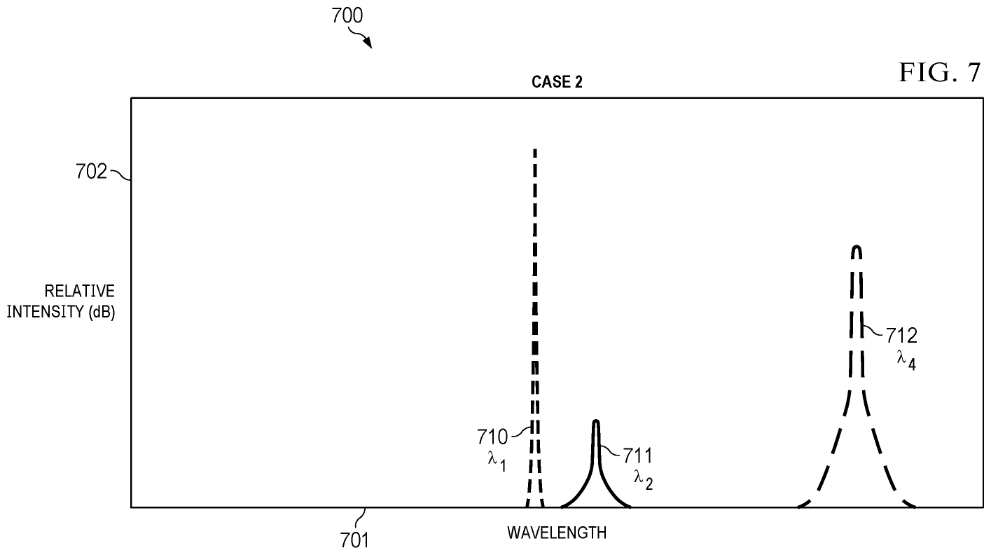

With reference next to FIG. 7, an illustration of relative intensity of backscatter light and a laser beam from a laser is depicted in accordance with an illustrative embodiment. Graph 700 is a graph of relative intensity of light or different wavelengths. As depicted, x-axis 701 is wavelength and y-axis 702 is relative intensity.

In this example, case 2 is shown in which line 710 is intensity for laser beam pulses 502 having wavelength λ1; line 711 is intensity for backscatter light 511 having wavelength λ2; and line 712 is intensity for backscatter light 510 having wavelength λ4. With this case, backscatter light 510 can also be filtered using optical filters to pass backscatter light 511. In this example, backscatter light 510 has a different wavelength from case 1 because laser beam pulses 502 are emitted at a different angle relative to the surface of blades 504.

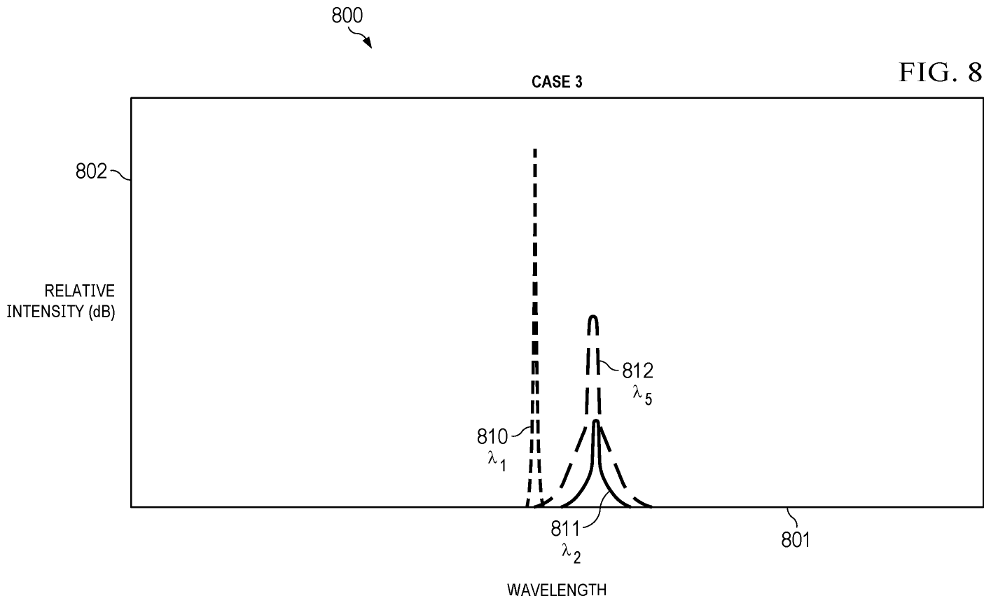

Next in FIG. 8, an illustration of relative intensity of backscatter light and a laser beam from a laser is depicted in accordance with an illustrative embodiment. Graph 800 is a graph of relative intensity of light or different wavelengths. As depicted, x-axis 801 is wavelength and y-axis 802 is relative intensity.

In this example, case 3 is shown in which line 810 is intensity for laser beam pulses 502 having wavelength λ1; line 811 is intensity for backscatter light 511 having wavelength λ2; and line 812 is intensity for backscatter light 510 having wavelength λ5 resulting from the angle at which laser beam pulses 502 hit the surface of blades 504.

In case 3, backscatter light 510 cannot be filtered to pass backscatter light 511. As depicted, backscatter light 510 has wavelength λ5, which is substantially the same wavelength backscatter light 511 having wavelength λ5. As a result, in this example, backscatter light 511 and backscatter light 510 have a different wavelength from case 1 because laser beam pulses 502 are emitted at a different angle relative to the surface of blades 504.

With this case, the emission of laser beam pulses 502 can be timed with respect to the rotor rotation rate of blades 504 to avoid hitting blades 504. In the illustrative example, sequential emitting of laser beam pulses 502 can be performed using an adjustable range rate and knowing the rotor rotation rate of blades 504. This timing is more difficult when laser beam pulses 502 are emitted simultaneously. Simultaneous emission of laser beam pulses 502 when multiple laser beam pulses are used involves emitting those laser beam pulses at different directions resulting in different timing for different laser beam pulses to avoid all of blades 504.

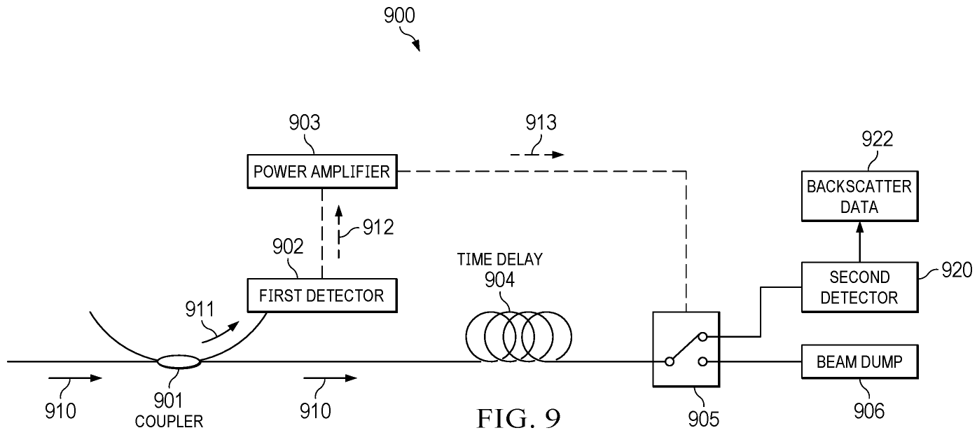

With reference now to FIG. 9, an illustration of a filter system for temporally filtering backscatter light is depicted in importance with an illustrative embodiment. In this illustrative example, filter system 900 is an example of a filter system that can be implemented in receiver 211 in FIG. 2. Filter system 900 can operate to separate backscatter light generated in response to laser beam pulses 220 in the blades 233.

As depicted, filter system 900 comprises coupler 901, first detector 902, power amplifier 903, time delay 904, switch 905, and beam dump 906.

In this example, backscatter light 910 is received by coupler 901. Coupler 901 is an optical coupler that diverts fraction 911 of backscatter light 910 to first detector 902. For example, coupler 901 is an optical coupler that diverts 1% of backscatter light 910 to first detector 902.

In this illustrative example, first detector 902 detects fraction 911 of backscatter light 910 diverted by coupler 901 and generates signal 912. In this example, signal 912 is an electrical signal.

Signal 912 is received by power amplifier 903 and is amplified by power amplifier 903 to form amplified signal 913. Amplified signal 913 is sent to switch 905.

In this illustrative example, switch 905 is normally in a position to pass backscatter light 910 for analysis. Backscatter light 910 can be passed to second detector 920, which generates backscatter data 922, which is an example of backscatter data 234 in FIG. 2.

The position of switch 905 can change to divert backscatter light 910 to beam dump 906 in response to amplified signal 913 being equal to or greater than a threshold. This threshold can be set as a level indicating that backscatter light 910 has a power level generated by a laser beam pulse being scattered by a blade. In this example, beam dump 906 can discard backscatter light 910 or send backscatter light 910 for analysis regarding characteristics of parameters of the blade.

In this illustrative example, time delay 904 is located between coupler 901 and switch 905. Time delay 904 can be the length of optical fiber that introduces a time delay to backscatter light 910. In this illustrative example, time delay 904 introduces a time delay that is equal to a time for backscatter light 910 traveling in a path that starts at coupler 901, travels through first detector 902, travels though power amplifier 903, and ends at switch 905.

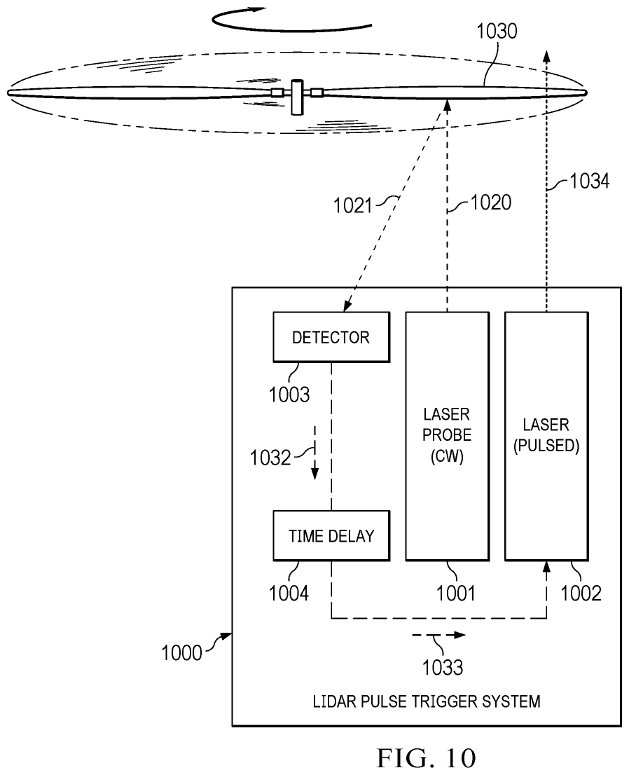

With reference now to FIG. 10, an illustration of a lidar pulse trigger is depicted in accordance with an illustrative embodiment. In this illustrative example, lidar pulse trigger system 1000 is an example of a system that can be used to avoid noise caused by backscatter light generated from laser beam pulses hitting blades on a rotorcraft. The system can be implemented in alternating pulsed lidar system 203 operating as synchronized alternating pulsed lidar system 209. As depicted, lidar pulse trigger system 1000 comprises laser probe 1001, laser 1002, detector 1003, and time delay 1004. Laser probe 1001 is an example of an implementation for laser source 224 that generates continuous wave laser beam 270 in FIG. 2. Laser 1002 is an example of laser source 224 that generates laser beam pulses 220 in FIG. 2.

In this illustrative example, laser probe 1001 emits continuous wave laser beam 1020. Continuous wave laser beam 1020 hits blades 1030 and generates laser probe backscatter light 1021 that is detected by detector 1003. When continuous wave laser beam 1020 does not hit blades 1030, probe backscatter light 1021 is not detected or is at a level that is not used by detector 1003 to generate a signal.

In response to detecting probe backscatter light 1021 at a level that indicates continuous wave laser beam 1020 hit blades 1030, detector 1003 generates signal 1032 that is delayed by time delay 1004. This time delay can be half of blade separation in time.

In other words, this time delay is the time it takes a single rotor blade to rotate half the angle between two adjacent rotator blades. For example, if adjacent rotor blades are separated by 90 degrees, and the rotation rate is 100 Hz, the time delay is 45/360*1/100=1.25 msec.

The output of time delay 1004 is trigger signal 1033. Trigger signal 1033 causes laser 1002 to emit laser beam pulse 1034 and passes between blades 1030. In other words, laser beam pulse 1034 passes through empty regions between blades 1030. As a result, lidar pulse trigger system 1000 can be used to avoid noise caused by laser beam pulse 1034 hitting blades 1030 and generating backscatter light from hitting blades 1030.

Continuous wave laser beam 1020 also passes between blades 1030. In this illustrative example, continuous wave laser beam 1020 can operate using at least one of a lower power, an eye-safe frequency, or other suitable characteristics. For example, at a lower power, energy can be conserved without needing to constantly emit laser beam pulses. As another example, the eye-safe frequency can be used for increased safety as continuous wave laser beam 1020 can be selected for these characteristics rather than to optimize the generation of backscatter from laser beam pulse 1034 scattering off of aerosols in the atmosphere.

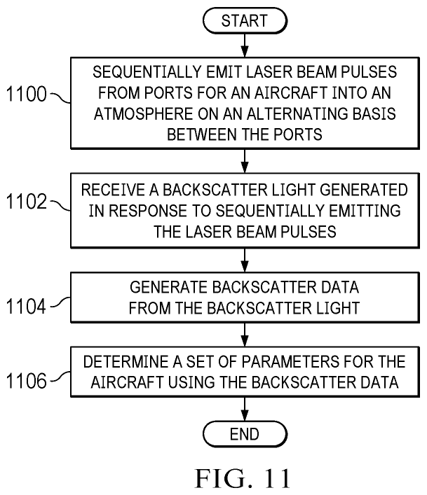

Turning next to FIG. 11, an illustration of a flowchart of a process for backscatter light detection is depicted in accordance with an illustrative embodiment. The process in FIG. 11 can be implemented in hardware, software, or both. When implemented in software, the process can take the form of program instructions that are run by one of more processor units located in one or more hardware devices in one or more computer systems. For example, the process can be implemented in alternating pulsed lidar system 203 in FIG. 2.

The process begins by sequentially emitting laser beam pulses from ports for an aircraft into an atmosphere on an alternating basis between the ports (operation 1100). The process receives a backscatter light generated in response to sequentially emitting the laser beam pulses (operation 1102). In operation 1102, sequentially emitting the laser beam pulses on the alternating basis between the ports can cause at least one of avoiding reducing a power of the laser beam pulses or reducing a drop in the power of the laser beam pulses.

The process generates backscatter data from the backscatter light (operation 1104). The process determines a set of parameters for the aircraft using the backscatter data (operation 1106). The process terminates thereafter.

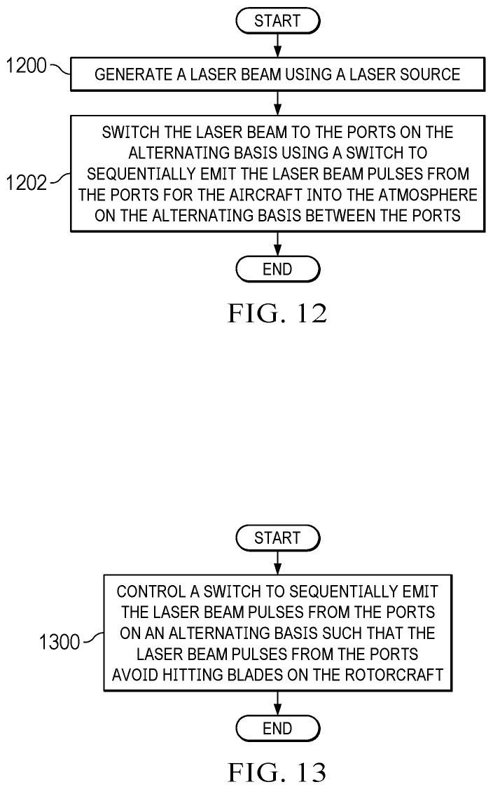

With reference now to FIG. 12, an illustration of a flowchart of a process for sequentially emitting laser beam pulses is depicted in accordance with an illustrative embodiment. The process in this flowchart is an example of an implementation for operation 1102 in FIG. 11.

The process generates a laser beam using a laser source (operation 1200). The process switches the laser beam to the ports on the alternating basis using a switch to sequentially emit the laser beam pulses from the ports for the aircraft into the atmosphere on the alternating basis between the ports (operation 1202). The process terminates thereafter.

Turning next to FIG. 13, an illustration of a flowchart of a process for synchronizing emission of laser beam pulses is depicted in accordance with an illustrative embodiment. The process in FIG. 13 can be implemented in hardware, software, or both. When implemented in software, the process can take the form of program instructions that are run by one of more processor units located in one or more hardware devices in one or more computer systems. For example, the process can be implemented in alternating pulsed lidar system 203 that operates as synchronized alternating pulsed lidar system 209 in FIG. 2. This process can be implemented in controller 201 in FIG. 2.

The process controls a switch to sequentially emit the laser beam pulses from the ports on an alternating basis such that the laser beam pulses from the ports avoid hitting blades on the rotorcraft (operation 1300). The process terminates thereafter.

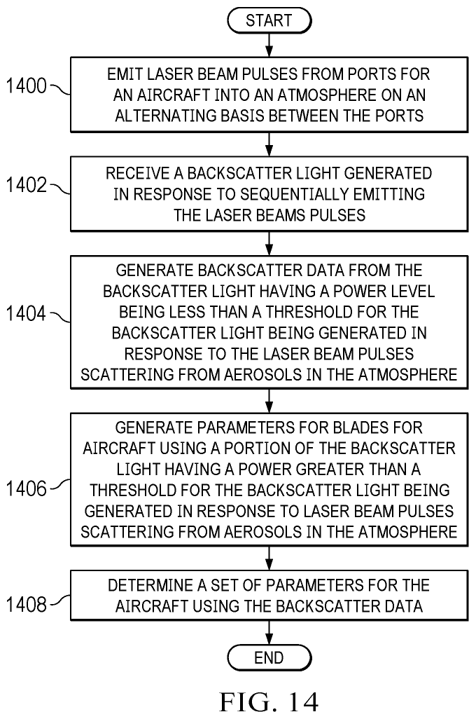

With reference to FIG. 14, an illustration of a flowchart of a process for synchronizing emission of laser beam pulses is depicted in accordance with an illustrative embodiment. The process in FIG. 14 can be implemented in hardware, software, or both. When implemented in software, the process can take the form of program instructions that are run by one of more processor units located in one or more hardware devices in one or more computer systems. For example, the process can be implemented in alternating pulsed lidar system 203 that operates as temporally filtered lidar system 250 in FIG. 2.

The process emits laser beam pulses from ports for an aircraft into an atmosphere on an alternating basis between the ports (operation 1400). The process receives a backscatter light generated in response to sequentially emitting the laser beam pulses (operation 1402).

The process generates backscatter data from the backscatter light having a power level being less than a threshold for the backscatter light being generated in response to the laser beam pulses scattering from aerosols in the atmosphere (operation 1404). The process generates parameters for blades for aircraft using a portion of the backscatter light having a power greater than a threshold for the backscatter light being generated in response to laser beam pulses scattering from aerosols in the atmosphere (operation 1406). In operation 1406, this backscatter light is generated by the laser beam pulses hitting the blades and scattering in response to hitting the blades.

The process determines a set of parameters for the aircraft using the backscatter data (operation 1408). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

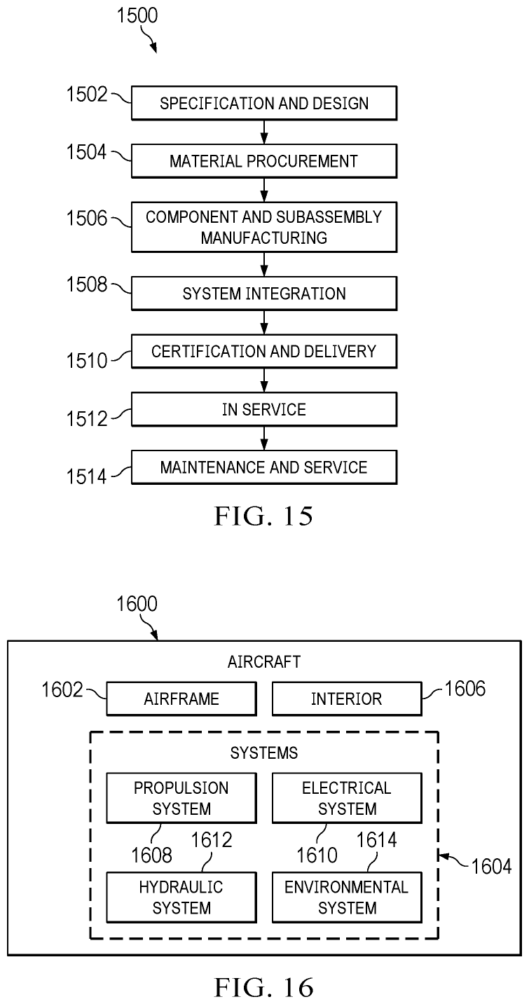

Illustrative embodiments of the disclosure may be described in the context of aircraft manufacturing and service method 1500 as shown in FIG. 15 and aircraft 1600 as shown in FIG. 16. Turning first to FIG. 15, an illustration of an aircraft manufacturing and service method is depicted in accordance with an illustrative embodiment. During pre-production, aircraft manufacturing and service method 1500 may include specification and design 1502 of aircraft 1600 in FIG. 16 and material procurement 1504.

During production, component and subassembly manufacturing 1506 and system integration 1508 of aircraft 1600 in FIG. 16 takes place. Thereafter, aircraft 1600 in FIG. 16 can go through certification and delivery 1510 in order to be placed in service 1512. While in service 1512 by a customer, aircraft 1600 in FIG. 16 is scheduled for routine maintenance and service 1514, which may include modification, reconfiguration, refurbishment, and other maintenance or service.

Each of the processes of aircraft manufacturing and service method 1500 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 16, an illustration of an aircraft is depicted in which an illustrative embodiment may be implemented. In this example, aircraft 1600 is produced by aircraft manufacturing and service method 1500 in FIG. 15 and may include airframe 1602 with plurality of systems 1604 and interior 1606. Examples of systems 1604 include one or more of propulsion system 1608, electrical system 1610, hydraulic system 1612, and environmental system 1614. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1500 in FIG. 15.

In one illustrative example, components or subassemblies produced in component and subassembly manufacturing 1506 in FIG. 15 can be fabricated or manufactured in a manner similar to components or subassemblies produced while aircraft 1600 is in service 1512 in FIG. 15. As yet another example, one or more apparatus embodiments, method embodiments, or a combination thereof can be utilized during production stages, such as component and subassembly manufacturing 1506 and system integration 1508 in FIG. 15. One or more apparatus embodiments, method embodiments, or a combination thereof may be utilized while aircraft 1600 is in service 1512, during maintenance and service 1514 in FIG. 15, or both. The use of a number of the different illustrative embodiments may substantially expedite the assembly of aircraft 1600, reduce the cost of aircraft 1600, or both expedite the assembly of aircraft 1600 and reduce the cost of aircraft 1600.

For example, alternating pulsed lidar system 203 can be implemented in aircraft 1600 during system integration 1508 or maintenance and service 1514. Further, alternating pulsed lidar system 203 can operate during in service 1512 to determine parameters for aircraft 1600 for use in controlling the operation of aircraft 1600.

Thus, the different illustrative examples provide a method, apparatus, and system for emitting laser beam pulses in the manner that is optimized for aerosol levels in the atmosphere. In one illustrative example, an alternating pulsed lidar system is comprised of a laser beam generator, a receiver, and an analyzer. The laser beam generator is configured to sequentially emit laser beam pulses from ports for an aircraft into an atmosphere on an alternating basis between the ports. The receiver is configured to receive a backscatter light generated in response to sequentially emitting the laser beam pulses and generate backscatter data from the backscatter light. The analyzer is configured to determine a set of parameters for the aircraft using the backscatter data.

In the illustrative example, when the density of aerosols in the atmosphere decreases, laser beam pulses can be sent from a laser source in a sequential manner that does not involve splitting the laser beam from the laser source to generate the laser beam pulses. As a result, the laser beam pulses can have a higher energy as compared to splitting the laser beam into the laser beam pulses and sending those pulses simultaneously.

Further, other illustrative examples can find emission of laser beam pulses to avoid blades. The timing is made easier through sequentially sending laser beam pulses rather than simultaneously sending laser beam pulses. In another illustrative example, backscatter light can be filtered in response to detecting backscatter light generated in response to laser beam pulses being scattered by blades on a rotorcraft.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. An alternating pulsed lidar system comprising:
a laser beam generator configured to sequentially emit laser beam pulses from ports for an aircraft into an atmosphere on an alternating basis between the ports;
a receiver configured to:
receive a backscatter light generated in response to sequentially emitting the laser beam pulses; and
generate backscatter data from the backscatter light; and
an analyzer configured to determine a set of parameters for the aircraft using the backscatter data.

2. The alternating pulsed lidar system of claim 1, wherein the laser beam generator comprises:
a laser source configured to generate a laser beam; and
a switch configured to:
receive the laser beam from the laser source; and
switch the laser beam received from the laser source to the ports on the alternating basis to sequentially emit the laser beam pulses from the ports for the aircraft into the atmosphere on the alternating basis between the ports.

3. The alternating pulsed lidar system of claim 2, wherein the laser beam generator further comprises:
a low power switch configured to:
receive the laser beam;
split the laser beam to form split laser beams; and
send the split laser beams to the ports for emission into the atmosphere;
wherein the switch is configured to send the laser beam to the low power switch in response to a determination of the set of parameters having a deviation greater than a threshold.

4. The alternating pulsed lidar system of claim 2, wherein the laser beam is at least one of a continuous wave laser beam or a pulsed laser beam that is sent to the switch.

5. The alternating pulsed lidar system of claim 2, wherein the switch is selected from a group consisting of an optical switch, an optical fiber switch, and a micro-electro-mechanical system switch.

6. The alternating pulsed lidar system of claim 1, wherein the laser beam pulses are N laser beam pulses that are sequentially emitted at a rate that is N times a sampling rate for the backscatter light.

7. The alternating pulsed lidar system of claim 1, wherein the set of parameters is selected from at least one of an airspeed, a temperature, an air density, an angle of sideslip, an angle of attack, wind speed, ice, aerosol properties, a presence of insects, turbulence, or open air turbulence.

8. The alternating pulsed lidar system of claim 1, wherein sequentially emitting the laser beam pulses on the alternating basis between the ports causes at least one of avoiding reducing a power of the laser beam pulses or reducing a drop in the power of the laser beam pulses.

9. The alternating pulsed lidar system of claim 1, wherein the alternating pulsed lidar system is a coherent lidar system.

10. The alternating pulsed lidar system of claim 1, wherein the alternating pulsed lidar system is located in a payload connected to the aircraft.

11. The alternating pulsed lidar system of claim 1, wherein the aircraft is selected from a group consisting of an airplane, a commercial aircraft, a rotorcraft, a helicopter, a tilt-rotor aircraft, a tilt wing aircraft, a vertical takeoff and landing aircraft, an electrical vertical takeoff and landing vehicle, a personal air vehicle, an unmanned aerial vehicle, and a drone.

12. An alternating pulsed lidar system comprising:
a laser beam generator comprising:
a laser source configured to generate a laser beam; and
a switch configured to:
receive the laser beam from the laser source;
split the laser beam into multiple laser beams; and
switch the multiple laser beams to different subsets of ports for an aircraft on an alternating basis to sequentially emit multiple laser beam pulses from the different subsets of ports into an atmosphere on the alternating basis between the different subsets of ports;
a receiver configured to:
receive backscatter light generated in response to sequentially emitting the laser beam pulses from the different subsets of ports; and
generate backscatter data from the backscatter light; and
an analyzer configured to determine a set of parameters for the aircraft using the backscatter data.

13. The alternating pulsed lidar system of claim 12, wherein the aircraft is selected from a group consisting of an airplane, a commercial aircraft, a rotorcraft, a helicopter, a tilt-rotor aircraft, a tilt wing aircraft, a vertical takeoff and landing aircraft, an electrical vertical takeoff and landing vehicle, a personal air vehicle, an unmanned aerial vehicle, and a drone.

14. The alternating pulsed lidar system of claim 12, wherein the aircraft is a rotorcraft and wherein the receiver is further configured to:
identify the backscatter light occurring from the laser beam pulses hitting blades on the rotorcraft; and
filtering out the backscatter light occurring from the laser beam pulses hitting the blades.

15. A method for backscatter light detection, the method comprising:
sequentially emitting laser beam pulses from ports for an aircraft into an atmosphere on an alternating basis between the ports;
receiving a backscatter light generated in response to sequentially emitting the laser beam pulses;
generating backscatter data from the backscatter light; and
determining a set of parameters for the aircraft using the backscatter data.

16. The method of claim 15, wherein said sequentially emitting the laser beam pulses comprises:
generating a laser beam using a laser source; and
switching the laser beam to the ports on the alternating basis using a switch to sequentially emit the laser beam pulses from the ports for the aircraft into the atmosphere on the alternating basis between the ports.

17. The method of claim 16, wherein the laser source generates the laser beam that is at least one of a continuous wave laser beam or a pulsed laser beam that is sent to the switch.

18. The method of claim 15, wherein the laser beam pulses are N laser beam pulses that are sequentially emitted at a rate that is N times a sampling rate for the backscatter light.

19. The method of claim 15, wherein the set of parameters is selected from at least one of an airspeed, a temperature, an air density, an angle of sideslip, an angle of attack, wind speed, ice, aerosol properties, a presence of insects, or turbulence.

20. The method of claim 15, wherein sequentially emitting the laser beam pulses on the alternating basis between the ports causes at least one of avoiding reducing a power of the laser beam pulses or reducing a drop in the power of the laser beam pulses.

21. The method of claim 15, wherein the method is used by a coherent lidar system.

22. The method of claim 15, wherein the ports are located in the aircraft.

23-39. (canceled)
